(19) United States
(12) Patent Application Publication
(10) Pub. No.: US 2015/0346319 A1
(43) Pub. Date: Dec. 3, 2015

(54) Method and Device for Determining the Position Coordinates of a Target Object

(71) Applicant: HILTI AKTIENGESELLSCHAFT, Schaan (LI)

(72) Inventors: Christoph WUERSCH, Werdenberg (CH); Andreas WINTER, Feldkirch (AT); Torsten GOGOLLA, Schaan (LI); Till CRAMER, Jenins (CH); Herwig HABENBACHER, Feldkirch-Tosters (AT)

(73) Assignee: Hilti Aktiengesellschaft, Schaan (LI)

(21) Appl. No.: 14/654,418

(22) PCT Filed: Dec. 11, 2013
(86) PCT No.: PCT/EP2013/076228

§ 371 Date: Jun. 19, 2015

(30) Foreign Application Priority Data
Dec. 20, 2012 (DE) 10 2012 223 924.3

(51) Int. Cl. G01S 5/16; G01C 15/00

(52) U.S. Cl. CPC G01S 5/16; G01C 15/002

(57) ABSTRACT

A method for determining the position coordinates of a target object in a measurement field in at least two dimensions is disclosed. In a first step, a target device is positioned with a reflector element on the target object and a first basic distance between a first and a second laser distance measuring device is determined. In a second step, a first distance from the first laser distance measuring device to the target object and a second distance from the second laser distance measuring device to the target object are determined by laser distance measurement by the laser distance measuring devices. In a third step, the position coordinates of the target object are calculated from the distances by a control device.

This application claims the priority of International Application No PCT/EP2013/076228, filed Dec. 11, 2013, and German Patent Document No. 10 2012 223 924.3, filed Dec. 20, 2012, the disclosures of which are expressly incorporated by reference herein.

### BACKGROUND AND SUMMARY OF THE INVENTION

The present invention relates to a method for determining the position coordinates of a target object and a device for determining the position coordinates of a target object.

DE 10 2010 023 461 A1 discloses a device for determining two-dimensional position coordinates of a target object, consisting of a target device, a first measuring device, designed as a rotating laser, emitting a first rotating laser beam, a second measuring device, designed as a rotating laser, emitting a second rotating laser beam and a control device having a control element and an evaluation element. The two rotating lasers and the target device are connected to the control device by suitable communication links. The target device comprises a reflector element, which is mounted on the target object and marks the position coordinates of the target object, and two receiving elements, which are mounted on the rotating lasers and detect the laser beams reflected on the reflector element. The first rotating laser beam is reflected on the reflector element and strikes the first receiving element of the target device, which sends a first information signal to the control device on reception of the first laser beam. The second rotating laser beam is reflected on the reflector element and strikes the second receiving element, which sends a second information signal to the control device on reception of the second laser beam. The control device receives information about the points in time when the first and second laser beams were detected by the receiving elements via the information signals sent by the receiving elements to the control device. The two rotating lasers are each equipped with an angle measuring device. At the point in time when the receiving elements receive the respective laser beam, the current angle of the rotating laser is detected by the angle measuring device and transmitted to the control device. The evaluation element calculates the position coordinates of the target object by triangulation from the known position coordinates of the two rotating lasers and the detected angles between the rotating lasers and the target object. Triangulation based on the fundamental idea that a triangle has three sides and three interior angles and that the three unknown variables of the triangle can be calculated by using these three known variables.

The known device for determining the position coordinates of a target object has the disadvantage that the first and second measuring devices each require an angle measuring device, which increases the complexity and the cost of the measuring devices. Furthermore, the known device is suitable only for determining two-dimensional position coordinates within a measurement plane, but three-dimensional position coordinates in a measurement space cannot be determined. A simultaneous measurement is impossible due to the rotating laser beams of the two measuring devices. A delayed measurement leads to measurement errors in the position coordinates of the target object, in particular in the case of target objects moving rapidly within the measurement plane. Determination of the position coordinates by triangulation based on angle measurement also has the disadvantage that the measurement error is proportional to the distance. In particular at great distances, for example, greater than 30 meters, a high accuracy of the angle measuring devices is required, but that further increases the cost of the angle measuring devices and therefore the known device for determining the position coordinates.

EP 0 717 261 B1 describes a device for determining three-dimensional position coordinates of a target object in a three-dimensional measurement space by triangulation. The three-dimensional measurement space is subdivided into a two-dimensional measurement plane and a direction perpendicular to the measurement plane. The device consists of a target device, which marks the target object, a horizontal device for determining the two dimensional position coordinates of the target object in the measurement plane and a vertical device for determining the position coordinates of the target object in the perpendicular direction as well as a control device having a control element and an evaluation element. The horizontal device comprises a first measuring device, which is designed as a rotating laser and emits a first laser beam, which rotates in the measurement plane, and comprises a second measuring device, which is designed as a rotating laser, emitting a second laser beam, which rotates in the measurement plane. The vertical device comprises a third measuring device, which is designed as a rotating laser, emitting a third laser beam, which rotates and is perpendicular to the measurement plane. The rotating lasers and the target device are connected to the control device via suitable communication links. Each rotating laser comprises a transmitting element, which emits the laser beam, a transmitter, which emits an information signal, and a reference mark, which defines a reference angle. When the rotating laser beam passes over the reference mark, the transmitter emits an information signal that is transmitted to the target device and is detected by a detector of the target device. The target device comprises a first detector for receiving the laser beams and a second detector for receiving the information signals. The first detector has a plurality of receiving elements, which emit an electric pulse when hit by a laser beam. The electric pulse is transmitted to the control device via the communication link. From the points in time when the laser beams and the information signals are detected by the target device, the control device determines the angles of the target object.

The known device for determining the position coordinates of a target object has the disadvantage that a high accuracy in the angle measurements increases the demands of the rotational angular velocities. The rotational angular velocity must be very uniform in particular at great distances, for example, greater than 30 meters. The high constancy of the rotational angular velocity requires a highly precise and complex mechanism, which makes this mechanism very expensive, on the one hand, and highly susceptible to error, on the other hand. A simultaneous measurement is impossible due to the rotating laser beams. A delayed measurement leads to measurement errors in the position coordinates of the target object, in particular in the case of target objects moving rapidly within the measurement field.

The object of the present invention consists of developing a method for determining the position coordinates of a target object in two or three dimensions, which is suitable for use in interior spaces and supplies accurate position coordinates for the target object. Furthermore, a device suitable for the method according to the invention should be developed for determining the position coordinates of a target object, wherein the position coordinates can be determined with a high precision with a limited equipment investment.

According to the invention, the method for determining the position coordinates of a target object in a measurement field in at least two dimensions is characterized in that:
in a first step, a target device having a reflector element is positioned on the target object, and a first basic distance between a first and a second laser distance measuring device is determined,
in a second step, a first distance from the first laser distance measuring device to the target object and a second distance from the second laser distance measuring device to the target object are determined by laser distance measurement by means of the laser distance measuring devices, and
in a third step, the position coordinates of the target object are calculated from the distances by means of a control device.

Determining the position coordinates of a target object with the help of laser distance measuring devices has the advantage that it does not require an expensive angle measuring device, and the position coordinates can nevertheless be determined with a high precision. Laser distance measurement is an established technology, and laser distance measuring devices have a cost advantage in comparison with total stations having not only a laser distance measuring device but also an angle measuring device. The two partial steps of the first step, namely positioning the target device on the target object and ascertaining the first basic distance, can be carried out in any order or simultaneously.

In a refinement of this method, in the first step, a second basic distance between the first and the third laser distance measuring devices and/or a third basic distance between the second and the third laser distance measuring devices is/are additionally ascertained. In the second step, a third distance from the third laser distance measuring device to the target object is additionally ascertained by laser distance measurement performed by using the third laser distance measuring device, and in the third step, the position coordinates of the target object are additionally calculated from the third distance and from the second and/or third basic distance(s). Due to the use of a third laser distance measuring device, the accuracy with which the two dimensional position coordinates are determined in a measurement plane can be increased. The accuracy decreases as the target object comes closer to the connecting line between the first and second laser distance measuring devices. The third laser distance measuring device also permits determination of three-dimensional position coordinates of a target object in a measurement space. The geometry of the target device, the arrangement of the laser distance measuring devices in the measurement range and the widening and/or movement of the laser beams determine whether the device can be used for determining two-dimensional or three-dimensional position coordinates. A target device in the form of a circular cylinder or a section of a circular cylinder is used for determining two-dimensional position coordinates, and a target device in the form of a sphere or a section of a sphere is used for determining three-dimensional position coordinates.

In the special case when the three laser distance measuring devices form a right-angled triangle, only one additional basic distance is necessary in addition to the first basic distance between the first and second laser distance measuring devices, namely either the second basic distance between the first and third laser distance measuring devices or the third basic distance between the second and third laser distance measuring devices. In all other cases, in which the three laser distance measuring devices do not form a right-angled triangle, the second and third basic distances are required for determination of the position coordinates and are ascertained in the first step of the method according to the invention.

The first, second and/or third basic distances are preferably ascertained by laser distance measurement using the first, second and/or third laser distance measuring devices. Since the distances from the target object to the laser distance measuring devices are determined by laser distance measurement, it is advantageous to also determine the basic distances between the laser distance measuring devices by means of laser distance measurement. In comparison with mechanical spacers having a measurement scale, laser distance measurement offers the advantage of a greater range. Furthermore, the laser distance measurement of the basic distances can be integrated more easily into an automated sequence of method steps.

A laser distance measurement to/from the other laser distance measuring devices is preferably performed in particular by each laser distance measuring device, and the basic distances between the laser distance measuring devices are averaged from a plurality of distance values. By averaging the basic distances from a plurality of distance values, the accuracy of the basic distances and thus the accuracy of the position coordinates of the target object are increased.

The laser distance measurement from the first, second and/or third laser distance measuring device to the target object is preferably triggered simultaneously by the control device. Simultaneous triggering of the laser distance measurements has the advantage that measurement errors are reduced, in particular in the case of rapidly moving target objects.

In particular for executing the method according to the invention, the device for determining the position coordinates of a target object in a measurement field in at least two dimensions comprises:
a target device having a reflector element, which defines the position coordinates of the target object,
a first laser distance measuring device having a first transmitting element, which emits a first laser beam, and also having a first receiving element, which receives a first laser beam as the first reception beam, which is at least partially reflected by the reflector element,
a second laser distance measuring device having a second transmitting element, which emits a second laser beam, and also having a second receiving element, which receives a second laser beam as the second reception beam, which is at least partially reflected by the reflector element, and also a second control element, and
a control device having a control element for controlling the laser distance measuring devices and having an evaluation element for calculating the position coordinates of the target object.

The device according to the invention makes it possible to determine the position coordinates of a target object with a high precision without an angle measuring device. Due to the fact that an angle measuring device is not necessary, it is possible to implement an inexpensive device, which can measure the position coordinates of the target object with a high precision. Laser distance measuring devices have a cost advantage in comparison with total stations using an angle measuring device.

A third laser distance measuring device, which is preferably provided, has a third transmitting element, which emits a third laser beam, a third receiving element, which receives a third laser beam as the third reception beam, which is at least partially reflected by the reflector element, and has a third control element. The third laser distance measuring device increases the precision, with which the position coordinates can be determined, in determination of two-dimensional position coordinates in a measurement plane and makes it possible to determine three-dimensional position coordinates. The geometry of the target device, the arrangement of the laser distance measuring devices and the widening and/or movement of the laser beams decide whether the device can be used for determining two-dimensional or three-dimensional position coordinate. The greater the number of laser distance measuring devices used, the more accurately the position coordinates of the target object can be determined and the problem of shaded lines of sight from the laser distance measuring devices to the target device is solved. In the case of two-dimensional position coordinates in the measurement plane, the three laser beams propagate in parallel with the measurement plane. To determine three-dimensional position coordinates in space, at least one laser beam that is not parallel to a plane must propagate.

The first, second and/or third laser distance measuring devices preferably have a reflective surface for reflecting the first, second and/or third laser beams. The basic distances between the laser distance measuring devices can be determined with the help of the reflective surfaces. A reflective surface is especially preferably provided on each laser distance measuring device, and the basic distances between the laser distance measuring devices can be averaged from a plurality of distance values, so that the accuracy of the basic distances is increased.

In a first variant, the first, second and/or third laser distance measuring devices have a beam-shaping lens, which widens the first, second and/or third laser beams with an opening angle greater than 80°. The widening of the laser beams may take place in one or two directions perpendicular to the direction of propagation of the laser beams. Widening in one direction creates a laser beam, which is suitable for determination of two-dimensional position coordinates, and widening in two directions creates a laser beam widened in the form of a spherical segment for the determination of three-dimensional position coordinates. Widening of the laser beams by beam-shaping lenses offers the possibility of using stationary laser distance measuring devices. In the case of stationary laser distance measuring devices, the laser distance measurements can be resolved simultaneously, which is advantageous in the case of rapidly moving target objects and reduces the measurement error. The laser distance measuring devices are also positioned and oriented outside of the measurement field or at the edge of the measurement field in such a way that the widened laser beams can detect the entire measurement field. Widening of the laser beams with an opening angle greater than 80° is suitable in particular for determination of two-dimensional position coordinates. if the laser beam is widened in the form of a spherical segment in two perpendicular directions by an opening angle greater than 80°, then in the case of a limited power of the laser beam, there is the risk that the power density of the reception beam might be too low for analysis. If sufficient power is available for the laser beam, then a laser beam widened in the form of a spherical segment with opening angles greater than 80° can be used to determine three-dimensional position coordinates.

The term “beam-shaping lens” is understood to include all beam-shaping optical elements, which widen, collimate or focus a laser beam. The beam-shaping lens may consist of an optical element with one or more optical functions integrated into it or a plurality of optical elements arranged in succession. Cylindrical lenses, conical mirrors and similar optical elements are suitable as beam-shaping lenses for widening a laser beam.

The beam-shaping lens especially preferably widens the first, second and/or third laser beams in a direction essentially parallel to the plane of the measurement. The beam-shaping lens collimates or focuses the first, second or third laser beams especially preferably in a direction essentially perpendicular to the measurement plane. This beam-shaping lens is suitable in particular for the determination of two-dimensional position coordinates and has the advantage that the available power of the laser beam is optimally utilized. In the determination of two-dimensional position coordinates in the measurement plane, no widening of the laser beams is necessary in the direction perpendicular to the measurement plane. The limited power of the laser beam is distributed in the measurement plane. Without any special safety measures, laser sources of laser class 2 may have a maximum power of 5 mW. If the laser beam is widened too much, there is the risk that the power density of the reception beam will be too low to be reliably detected and analyzed by the receiving element.

In a second variant, the first, second and/or third laser distance measuring devices have a motor unit, wherein the motor unit moves the first, second and/or third laser beams about an axis of rotation that is perpendicular to the measurement plane or about a pivot point. Rotation of the laser beams is recommended when the power density of the laser beams is too low after widening to obtain a sufficiently strong reception beam for the laser distance measurement. Rotation of the laser beams about the axis of rotation perpendicular to the measurement plane can be carried out as a rotating, scanning or tracking movement. In the rotating movement, the laser beams are rotated continuously about the axis of rotation, in the scanning movement, the laser beams are moved periodically back and forth about the axis of rotation, and in the tracking movement, the laser beams follow the target device. The rotation of the laser beams about a pivot point is provided for the determination of three-dimensional position coordinates and is preferably used with a tracking device that tracks the moving target device. The motor unit of the second variant can be combined with a beam-shaping lens, which collimates or focuses the laser beams.

In a third variant, the first, second and/or third laser distance measuring devices have a beam-shaping lens and a motor unit, wherein the beam-shaping lens widens the first, second and/or third laser beams with an opening angle of up to 10°, and the motor unit moves the first, second and/or third widened laser beams about an axis of rotation perpendicular to the measurement plane or about a pivot point. The widening of the laser beams and the rotation about an axis of rotation (two-dimensionally) or a pivot point (three-dimensionally) can be combined with one another. The laser beams are widened up to 10° by a beam-shaping lens, and the widened laser beams are moved by a motor unit about an axis of rotation or about a pivot point. The combination of beam widening and rotation permits detection of reception beams having a sufficiently strong power density for the reception beam. The laser beams may be widened in one direction or in two directions perpendicular to the direction of propagation of the laser beams. The rotation of the laser beams may be implemented as a rotating, scanning or tracking movement.

In a preferred embodiment, the reflector element is designed as a rotationally symmetrical body or as a section of a rotationally symmetrical body. Circular cylinders or sections of circular cylinders are suitable as the reflector element for two-dimensional measurements, and spheres or spherical sections are suitable for three-dimensional measurements. A rotationally symmetrical body has the advantage that the distance from the surface to the midpoint is the same from all directions. The position coordinates of the target object are situated on the circular cylinder or at the midpoint of the sphere. The radius of the circular cylinder or of the sphere is stored in the control unit or is input by the user into the control unit. For the calculation of the position coordinates, the radius of the target device is added to the measured distance between the laser distance measuring device and the target device. Furthermore, the displacement between the laser distance measuring device and the coordinate system of the device is also taken into account.

In a preferred embodiment, the target device of the device according to the invention is mounted on a handheld tool. During processing with the handheld machine tool, the current position coordinates of the tool can be ascertained using the device according to the invention.

Exemplary embodiments of the invention are described below on the basis of the drawings, which do not necessarily represent the exemplary embodiments drawn to scale, but instead the drawings are done in a schematic and/or slightly distorted form, where this serves the purpose of illustration. Reference is made to the relevant prior art with regard to additions to the teachings that are directly discernible from the drawings. It should be taken into account here that a variety of modifications and changes can be made with regard to the shape and details of a specific embodiment without going beyond the general idea of the invention. The features of the invention disclosed in the description, the drawings and the claims may be essential either individually or in any combination for the refinement of the invention. Furthermore, all combinations of at least two of the features disclosed in the description, the drawings and/or the claims fall within the scope of the invention. The general idea of the invention is not limited to the precise shape or details of the specific embodiment shown in the drawings and described below, nor is it limited to one subject matter, which would be restricted in comparison with the subject matter claimed in the patent claims. With given ranges of dimensions, values within the aforementioned limits shall also be considered as disclosed and may be used in any way and may also be claimed. For the sake of simplicity, the same reference numerals are used below for identical or similar parts or for parts with identical or similar functions.

### BRIEF DESCRIPTION OF THE DRAWINGS

FIGS. 1A, B show a first embodiment of a device according to the invention for determining two-dimensional position coordinates of a target object consisting of a target device, a first and a second laser distance measuring device and a handheld part (FIG. 1A) as well as a schematic diagram of the geometric relationships for determining the position coordinates (FIG. 1B);

FIG. 2 shows the device from FIG. 1 with the target device, the laser distance measuring devices and the handheld part in the form of a block diagram; and

FIG. 3 shows a second embodiment of a device according to the invention for determining position coordinates of a target object in three dimensions in a schematic diagram consisting of a target device and three laser distance measuring devices.

### DETAILED DESCRIPTION OF THE DRAWINGS

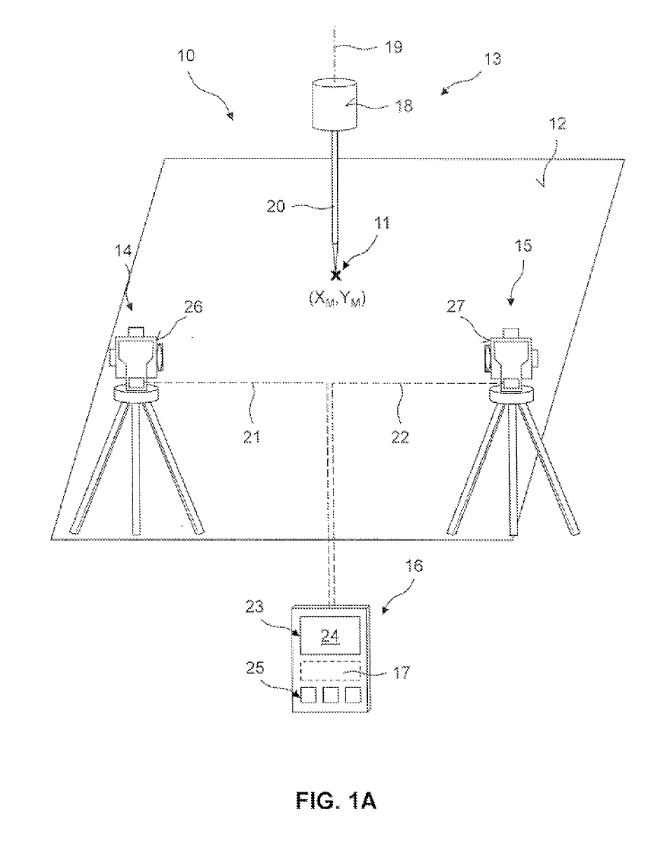

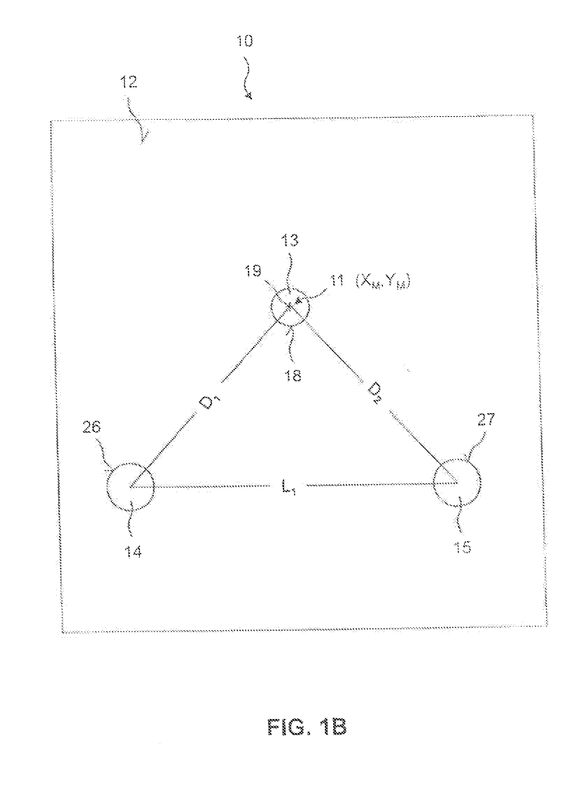

FIGS. 1A, B show a first embodiment of a device 10 according to the invention for determining the position coordinates X_{M}, Y_{M} of a target object 11 in a measurement field 12. The measurement field 12 is designed as a surface, and the position coordinates X_{M}, Y_{M} of the target object 11 are two-dimensional.

FIG. 1A shows the essential components of the device 10 in a schematic diagram. The device 10 comprises a target device 13, a first laser distance measuring device 14, a second laser distance measuring device 15 and a handheld part 16 with a control device 17. As an alternative to the separation of the target device 13 and the handheld part 16 as shown in FIG. 1A, the target device may also be integrated into the handheld part.

The position of the target object 11 in the measurement plane 12 is marked with the help of the target device 13. The target device 13 has a reflector element 18 for reflecting laser beams of the first and second laser distance measuring devices 14, 15. The reflector element 18 is designed as a circular cylinder in the embodiment shown in FIG. 1A and the position coordinates of the target object 11 lie on the cylinder axis 19 of the reflector element 18. For the device 10 according to the invention, it is important that the position coordinates of the target object 11, which are arranged at the midpoint, are the same distance from each point on the surface. This condition is met in the plane by a circle and/or a section of a circle. The distance from the surface of the reflector element 18 to the target object 11 is stored in the control device 17 or is input by the operator into the control device 17. The reflector element 18 may be attached to a surveyor's rod 20 and is positioned on the target object 11 by the operator. To align the cylinder axis 19 of the reflector element 18 perpendicular to the measurement plane 12, a leveling device, for example, in the form of a bubble level or seine other tilt sensor may be integrated into the surveyor's rod 20. As an alternative to the surveyor's rod 20, the target device 13 may be attached to a wall or a ceiling, placed on a floor or attached to a vehicle or a machine tool, for example.

The device 10 is operated by the handheld part 16 which the operator holds in the operator's hand. The first and second laser distance measuring devices 14, 15 perform one or more distance measurements and transmit the calculated distance values to the control device 17 in the handheld part 16. The laser distance measuring devices 14, 15 are connected to the control device 17 by means of communication links 21, 22. The handheld part 16 has a display device 23 with a display 24 and an operating device 25 in addition to the control device 17. The control device 17 of the device 10 is arranged in the handheld part 16 and is connected to the laser distance measuring devices 14, 15 by the communication links 21, 22. Alternatively, the control device 17 may be situated in the first or second laser distance measuring devices 14, 15.

FIG. 1B shows the geometric dimensions between the target device 13 and the laser distance measuring devices 14, 15 which are used to determine the two-dimensional position coordinates of the target object 11. The first and second laser distance measuring devices 14, 15 are spaced a distance apart from one another and are positioned in relation to the target object 11 so that the target object 11 does not lie on the connecting line between the laser distance measuring devices 14, 15. Otherwise a third laser distance measuring device is added to increase the accuracy when the target object 11 is positioned close to the connecting line. The two-dimensional position coordinates X_{M}, Y_{M} of the target object 11 are determined from a basic distance L₁ between the first and second laser distance measuring devices 14, 15, a first distance D₁ from the first laser distance measuring device 14 to the target object 11 and a second distance D₂ from the second laser distance measuring device 15 to the target object 11.

The basic distance L₁ can be ascertained by laser distance measurement of the first and/or second laser distance measuring devices 14, 15. To increase the accuracy of the laser distance measurement, the two laser distance measuring devices 14, 15 can perform a laser distance measurement and then the measured distances are averaged. A reflective surface, which reflects the laser beam of the other laser distance measuring devices 14, 15, is provided on the first and/or second laser distance measuring devices 14, 15. FIG. 1A shows an embodiment having a first reflective surface 26 on the laser distance measuring device 14 and a second reflective surface 27 on the second laser distance measuring 15. The first and second reflective surfaces 26, 27 are designed in the form of a circular cylinder or a section of a circular cylinder. For devices for determining three-dimensional position coordinates, spheres or sections of spheres are suitable as the reflective surfaces for ascertaining the basic distances. Alternatively, the first and second laser distance measuring devices 14, 15 may be mounted on a mechanical spacer with a measurement scale. The operator then reads the distance on the measurement scale and inputs the distance via an operating device 25.

After ascertaining the basic distance L₁, the first and second laser distance measuring devices 14, 15 each perform a laser distance measurement from the target object 11. The laser distance measurements from the target object 11 may be performed simultaneously or with a time lag. Simultaneous triggering of the laser distance measurements has the advantage that measurement errors are reduced in the case of rapidly moving target objects in particular. The distances L₁, D₁, D₂ thereby ascertained are transmitted to the control device 17, which calculates the two-dimensional position coordinates X_{M}, Y_{M} of the target object 11. The position coordinates X_{M}, Y_{M} of the target object 11 can then be transmitted to the display device 23, which presents the position coordinates for the user on the display 24. The distance measurements by the first and second laser distance measuring devices 14, 15 are performed in the internal coordinate system for the device 10 and must be linked to an external coordinate system for an absolute determination of the position coordinates of the target object 11.

In addition to a determination of position coordinates of a target object that is present, the device 10 may also be used to locate position coordinates. To do so, the user guides a reflector element, which is equipped with a measurement tip or the like and may also be integrated into a handheld part, over a measurement surface and seeks predefined position coordinates. The position coordinates can be input manually into the handheld part or are transmitted via a communication link from another device to the first device.

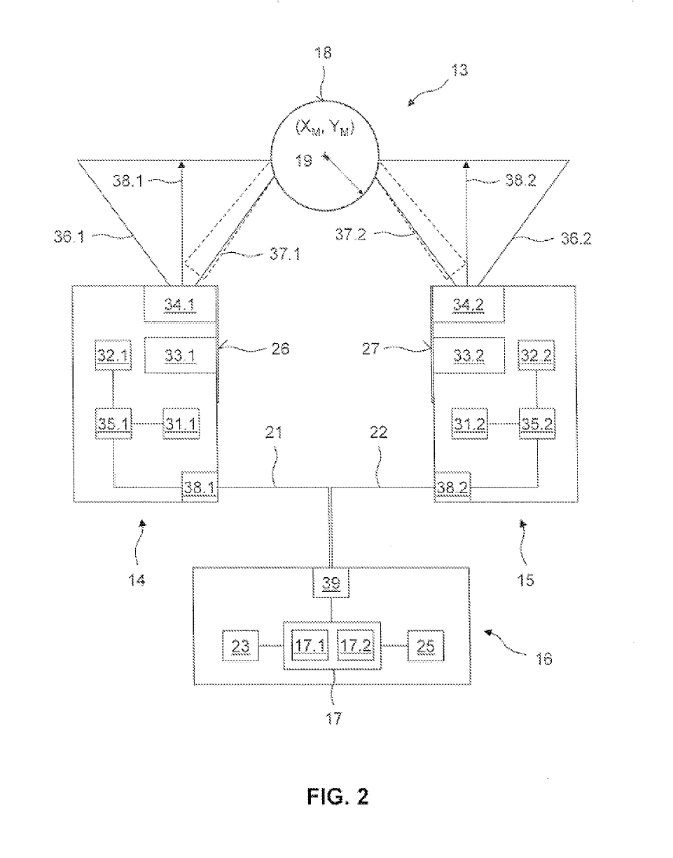

FIG. 2 shows the first and second laser distance measuring devices 14, 15, the target device 13 and the handheld part 16 of the device 10 in the form of a block diagram. The first and second laser distance measuring devices 14, 15 have a coaxial design and comprise a transmitting element 31 designed as a laser diode, a receiving element 32 designed as a photodetector, a beam splitting lens 33, a beam-shaping lens 34 and a control element 35. An index “0.1” identifies the components of the laser distance measuring device 14 and an index “0.2” identifies the components of the second laser distance measuring device 15. The laser diode 31 emits a laser beam 36, which is directed at the target object 11. A laser beam, which is at least partially reflected on the reflector element 18 of the target device 13, is detected as the reception beam 37 by the photodetector 32. The control element 35 is connected to the laser diode 31 and the photodetector 32 and determines the distance of the laser distance measuring devices 14, 15 to the target device 13 from the reception beam 37.

With the coaxial design of the laser distance measuring devices 14, 15 shown in FIG. 2, the laser beam 36 emitted by the laser diode 31 is separated spatially from the reception beam 37 with the help of the beam splitting lens 33. The beam splitting lens 33 is positioned in the beam path of the laser beam 36 between the laser diode 31 and the beam-shaping lens 34 and in the beam path of the reception beam 37 between the beam-shaping lens 34 and the photodetector 32. The beam-shaping lens 34 may be designed as a single optical element or as a system of a plurality of optical elements and it shapes both the laser beam 36 and the reception beam 37. In contrast with known laser distance measuring devices, which direct a focused point-shaped laser beam at the target object, it is necessary with the device 10 according to the invention for the laser beam 36 to detect a larger angular range. This can be achieved by widening the laser beam 36 in the measurement plane 12 or by rotating the laser beam 36 in the measurement plane 12. FIG. 2 shows the laser distance measuring devices 14, 15, in which the laser beams 36 are widened by a suitable beam-shaping lens 34. Cylindrical lenses and conical lens systems, among others, are suitable as the beam-shaping lenses 34.

Communication between the control device 17 and the laser distance measuring devices 14, 15 takes place via the communication link 21, 22, which connects a first transmitting and receiving element 38 in the laser distance measuring devices 14, 15 to a second transmitting and receiving element 39 in the handheld part 16. The calculations of the basic distance L₁ and the distances D₁, D₂ take place in the control elements 35.1, 35.2 of the laser distance measuring devices 14, 15. The distances L₁, D₁, D₂ are transmitted to the control device 17 over the communication links 21, 22. The control device 17 comprises a control element 17.1 for controlling the laser distance measuring devices 14, 15 and an evaluation element 17.2 for calculating the position coordinates of the target object 11. In the evaluation element 17.2 of the control device 17, the position coordinates of the target object 11 in the internal coordinate system of the device 10 are calculated from the distances L₁, D₁, D₂ and optionally transformed into an external coordinate system. In the case of stationary target objects, the position coordinates can be transmitted to the display device 23 and displayed on the display unit 24.

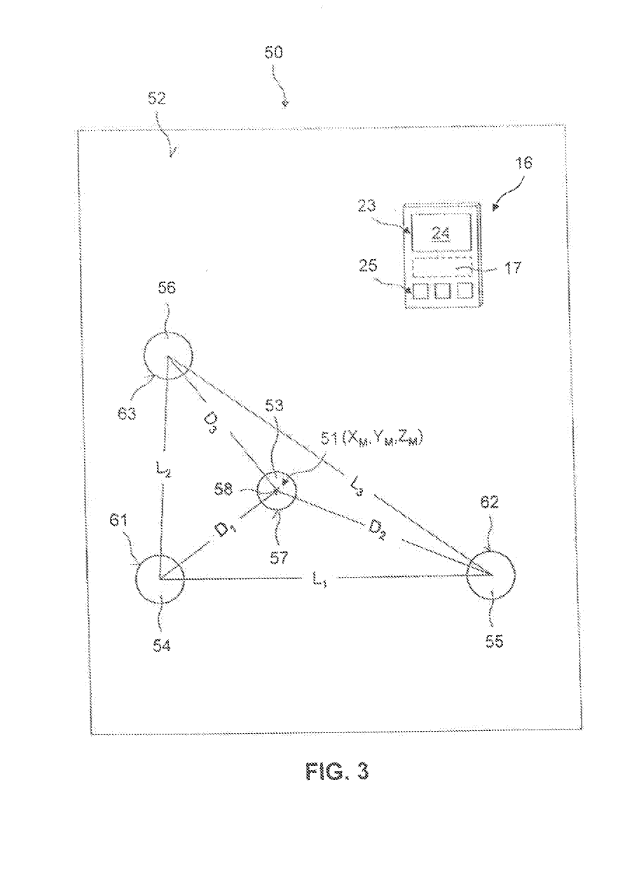

FIG. 3 shows a second embodiment of a device 50 according to the invention for determining the position coordinates X_{M}, Y_{M}, Z_{M} of a target object 51 in a measurement field 52. The device 50 differs from the device 10 of FIGS. 1A, B in that three laser distance measuring devices are provided. By using a third laser distance measuring device, the accuracy with which two-dimensional position coordinates are determined in a measurement plane can be increased. The accuracy declines, the closer the target object is placed to the connecting line between the first and second laser distance measuring devices. The third laser distance measuring device also makes it possible to determine three-dimensional position coordinates of a target object in a measurement space.

The device 50 comprises a target device 53, a first laser distance measuring device 54, a second laser distance measuring device 55 and a third laser distance measuring device 56 as well as the handheld part 16 with the control device 17. The geometry of the target device 53 and the arrangement of the laser distance measuring devices 54, 55, 56 decide whether the device 50 can be used for determining two-dimensional or three-dimensional position coordinates. A target device 53 in the form of a sphere or a section of a sphere is used for determining three-dimensional position coordinates. The sphere has a reflector element 57 on the outside, and the position coordinates of the target object 51 are located at the midpoint of the sphere of the reflector element 57.

The two-dimensional or three-dimensional position coordinates X_{M}, Y_{M}, Z_{M} of the target object 51 are determined from the basic distances L₁, L₂, L₃ between the laser distance measuring devices 54, 55, 56 and the distances D₁, D₂, D₃ of the laser distance measuring devices 54, 55, 56 from the target object 51. FIG. 3 shows an arrangement in which the laser distance measuring devices 54, 55, 56 do not form a right-angled. triangle. In the specific case when the three laser distance measuring devices 54, 55, 56 would form a right-angled triangle, in addition to the first basic distance L₁ between the first and second laser distance measuring devices 54, 55, only one additional basic distance would be necessary, either the second basic distance L₂ between the first and third laser distance measuring devices 54, 56 or the third basic distance L₃ between the second and third laser distance measuring devices 55, 56. In all other cases, the second and third basic distances L₂, L₃ are necessary and are determined in the first step of the method according to the invention.

Since the laser distance measuring devices 54, 55, 56 are arranged in stationary positions in the measurement field 52, the laser beams must be able to detect the measurement field 52. The widening of the laser beams may take place through beam-shaping optical elements, which widen a point-shaped laser beam in one or two directions perpendicular to the direction of propagation. Alternatively, the region detected by a laser beam can be enlarged by a rotating, scanning or tracking movement of the laser beam. The rotating or scanning movement of the laser beams is suitable in particular for determining two-dimensional position coordinates in a measurement plane. The laser beams are moved continuously around an axis of rotation perpendicular to the measurement plane (rotating movement) or they are moved periodically back and forth (scanning movement). The tracking movement of the laser beam is suitable for determining three-dimensional position coordinates in particular and is used with a tracking device, which tracks a moving target device.

1-15. (canceled)

16. A method for determining position coordinates of a target object in a measurement field in at least two dimensions, comprising the steps of:
in a first step, positioning a target device with a reflector element on the target object and determining a first basic distance between a first laser distance measuring device and a second laser distance measuring device;
in a second step, determining a first distance from the first laser distance measuring device to the target object and a second distance from the second laser distance measuring device to the target object by laser distance measurement by the first and the second laser distance measuring devices, respectively; and
in a third step, calculating the position coordinates of the target object from the first basic distance and the first and the second distances by a control device.

17. The method according to claim 16, wherein:
in the first step, a second basic distance between the first and a third laser distance measuring device and/or a third basic distance between the second and the third laser distance measuring device are determined;
in the second step, a third distance from the third laser distance measuring device to the target object is determined by laser distance measurement by the third laser distance measuring device; and
in the third step, the position coordinates of the target object are calculated from the third distance and the second basic and/or the third basic distances.

18. The method according to claim 17, wherein the first, the second, and/or the third basic distances are determined by laser distance measurement by the first, the second, and/or the third laser distance measuring devices.

19. The method according to claim 17, wherein the first, the second, and/or the third basic distances are averaged from two distance values.

20. The method according to claim 17, wherein the first, the second, and the third laser distance measurements are triggered simultaneously by the control device.

21. A device for determining position coordinates of a target object in a measurement field in at least two dimensions, comprising:
a target device having a reflector element, which defines the position coordinates of the target object;
a first laser distance measuring device having a first transmitting element which emits a first laser beam, a first receiving element which receives a first reception laser beam which is at least partially reflected by the reflector element, and a first control element;
a second laser distance measuring device having a second transmitting element which emits a second laser beam, a second receiving element which receives a second reception laser beam which is at least partially reflected by the reflector element, and a second control element; and
a control device having a control device control element, wherein the first and the second laser distance measuring devices are controllable by the control device control element, and an evaluation element, wherein the position coordinates of the target object are calculatable by the evaluation element.

22. The device according to claim 21, further comprising a third laser distance measuring device having a third transmitting element which omits a third laser beam, a third receiving element which receives a third reception laser beam which is at least partially reflected by the reflector element, and a third control element.

23. The device according to claim 22, wherein the first, the second, and/or the third laser distance measuring devices have a respective reflective surface.

24. The device according to claim 22, wherein the first, the second, and/or the third laser distance measuring devices have a respective beam-shaping lens which widens the first, the second, and the third laser beams respectively with an opening angle greater than 80°.

25. The device according to claim 24, wherein the respective beam-shaping lens widens the first, the second, and/or the third laser beams in a direction essentially parallel to a measurement plane.

26. The device according to claim 24, wherein the respective beam-shaping lens collimates or focuses the first, the second, and/or the third laser beams in a direction essentially perpendicular to a measurement plane.

27. The device according to claim 22, wherein the first, the second, and/or the third laser distance measuring devices respectively have a motor unit, wherein the motor unit pivots the first, the second, and/or the third laser beams around an axis of rotation perpendicular to a measurement plane or around a pivot point.

28. The device according to claim 22, wherein the first, the second, and/or the third laser distance measuring devices have a respective beam-shaping lens and a motor unit, wherein the beam-shaping lens widens the first, the second, and/or the third laser beams with an opening angle of up to 10°, and wherein the motor unit moves the first, the second, and/or the third widened laser beams around an axis of rotation perpendicular to a measurement plane or around a pivot point.

29. The device according to claim 21, wherein the reflector element is a rotationally symmetrical body or is a section of a rotationally symmetrical body.

30. The device according to claim 21, wherein the target device is mounted on a handheld tool.
